(19) United States
(12) Patent Application Publication
(10) Pub. No.: US 2025/0133982 A1
(43) Pub. Date: May 1, 2025

(54) Seed Boot

(71) Applicant: Precision Planting LLC, Tremont, IL (US)

(72) Inventors: Jeremy J. Hodel, Morton, IL (US); Paul Wildermuth, Tremont, IL (US)

(21) Appl. No.: 18/691,165

(22) PCT Filed: Oct. 3, 2022
(86) PCT No.: PCT/IB2022/059419

§ 371 Date: Mar. 12, 2024

Related U.S. Application Data
(60) Provisional application No. 63/262,415, filed on Oct. 12, 2021.

(51) Int. Cl. A01C 5/06; A01C 7/20

(52) U.S. Cl. CPC A01C 5/062; A01C 7/20

(57) ABSTRACT

A seed boot (700) having a leading edge (701): a channel (702) for transporting seed opposite the leading edge (701), wherein the channel (702) has a first end (703) and a second end (704), and further comprising a channel exit (705) at the second end (704): a wedge (707) for forming a trench disposed at a bottom of the seed boot (700)), wherein the wedge (707) extends from the leading edge (701) and terminates before the channel exit (705).

### CROSS REFERENCE TO RELATED APPLICATIONS

This application claims priority to U.S. Provisional Application No. 63/262,415, filed 12 Oct. 2021, the disclosure of which is incorporated herein by reference in its entirety.

### BACKGROUND

There are various ways to form a furrow for planting seeds. Typical methods include a double disc opener on a row unit for creating a v-shaped trench (such as for planter row units), a single disc opener (such as for seeder row units), and seed boots. These methods typically create a wide trench to accept a seed deposited from a seed tube.

### BRIEF DESCRIPTION OF THE DRAWINGS

FIG. 1 is top perspective view of a seed boot.

FIG. 2 is a bottom perspective view of the seed boot of FIG. 1.

FIG. 3 is a section view of the seed boot of FIG. 1.

FIG. 4 is a right side elevation view of the seed boot of FIG. 1.

FIG. 5 is a left side elevation view of the seed boot of FIG. 1.

FIG. 6 is a top plan view of the seed boot of FIG. 1.

FIG. 7 is a bottom plan view of the seed boot of FIG. 1.

FIG. 8 is a rear elevation view of the seed boot of FIG. 1.

FIG. 9 is a front elevation view of the seed boot of FIG. 1.

FIG. 10 is a perspective view of the seed boot of FIG. 1 with a cover.

FIG. 11 is a top plan view of the seed boot of FIG. 1 with a cover.

FIG. 12 is a right side elevation view of the seed boot of FIG. 1 in combination with a coulter.

FIG. 13 is a right side elevation view of the seed boot of FIG. 1 on a row unit in combination with a coulter.

FIG. 14 is a perspective view of a seed boot and coulter on a row unit.

FIG. 15 is a right side elevation view of the seed boot of FIG. 1 on a row unit in combination with a coulter and a seed orientation coil.

### DETAILED DESCRIPTION

All references cited herein are incorporated herein in their entireties. If there is a conflict between a definition herein and in an incorporated reference, the definition herein shall control.

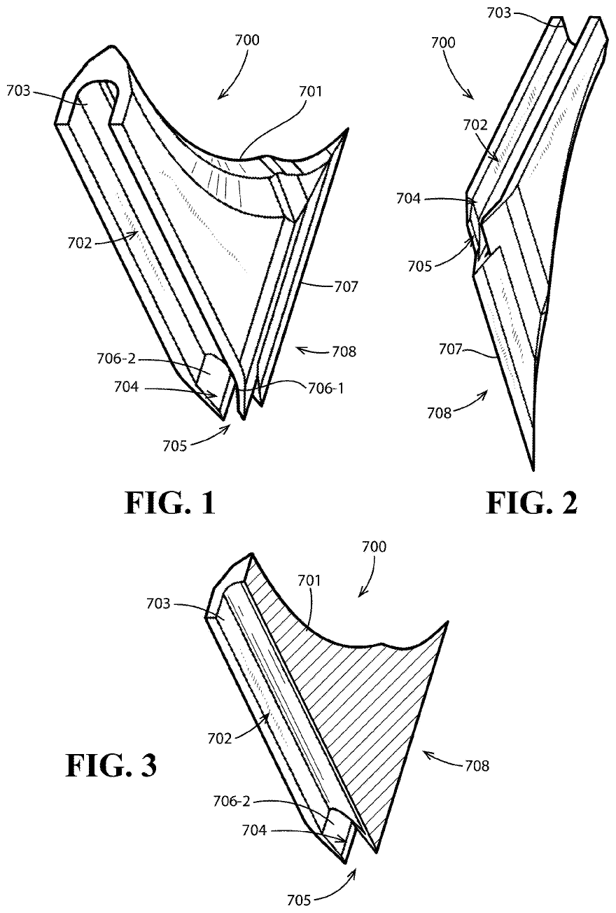

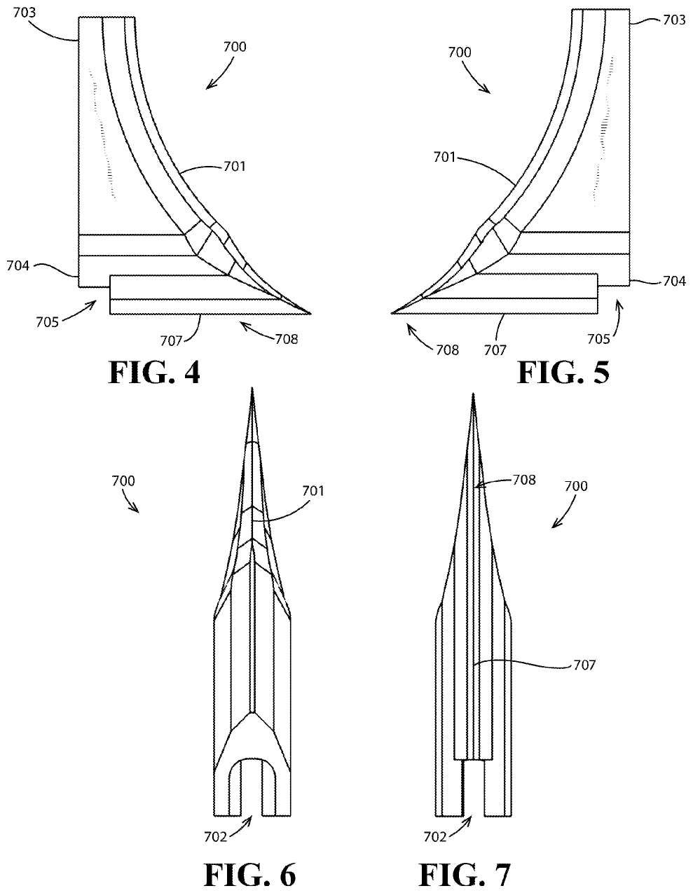

Referring to the drawings, wherein like reference numerals designate identical or corresponding parts throughout the several views, FIGS. 1 to 9 illustrate a seed boot.

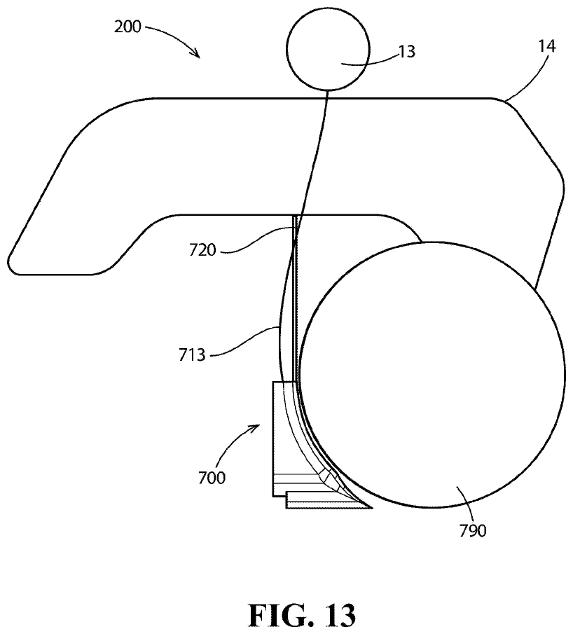

Seed boot 700 has a leading edge 701. Leading edge 701 can have a knife shaped edge, which can help move through soil. Opposite leading edge 701 along a direction of travel is a channel 702 for conveying seeds. Channel 702 can be in communication with a conduit 713 (as illustrated in FIG. 13) to receive seeds from a seed meter 13.

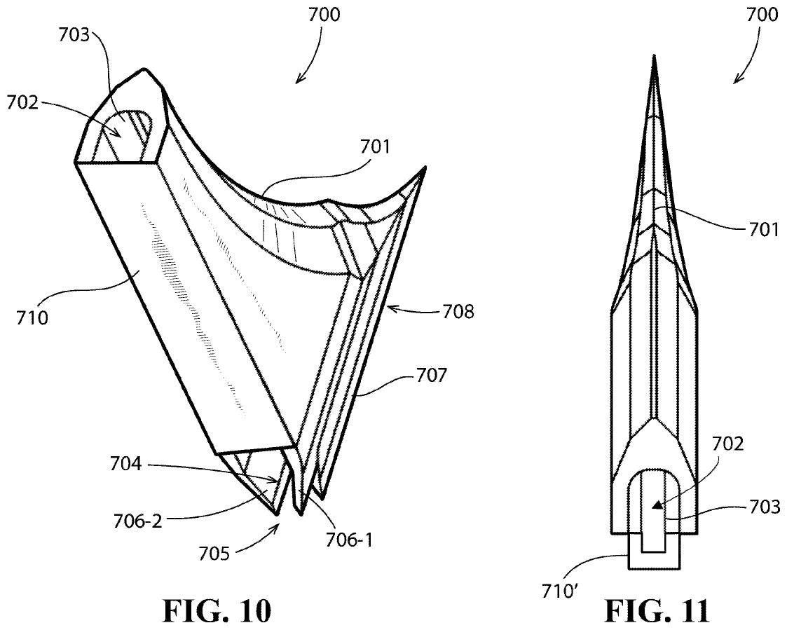

Channel 702 has a top end 703 and a bottom end 704. At bottom end 704, there is a channel exit 705. Optionally, leading to channel exit 705, bottom end 704 can have sloped sides 706 (706-1, 706-2) sloping towards a middle of channel 702 and descending to channel exit 705. A cover 710 can enclose channel 702 as illustrated in FIG. 10. Channel 702 can be enlarged with cover 710′ as illustrated in FIG. 11 in which cover 710′ is a U-shaped channel.

At the bottom 705 of seed boot 700 is wedge 707. Wedge 707 extends from leading edge 701 and ends before channel exit 705. Wedge 707 can be v-shaped.

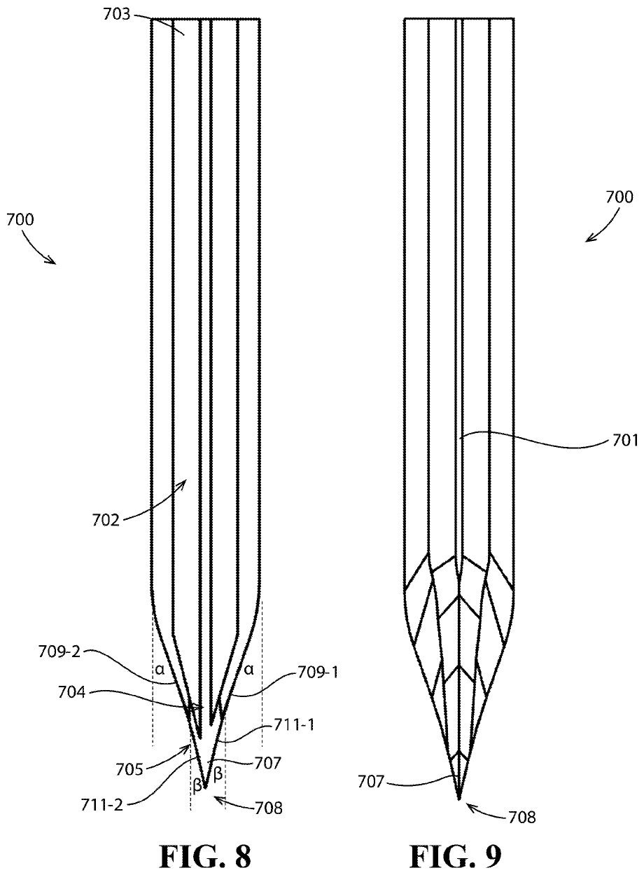

Seed boot 700 has lower walls 709 (709-1, 709-2) as seen in FIG. 8. Lower walls 709 (709-1, 709-2) have an angle α with respect to vertical. Wedge 707 has walls 711 (711-1, 711-2) and they have an angle β with respect to vertical. Angles α and β can be different. Angle α can be greater than angle β. This can form the narrow trench for seeds.

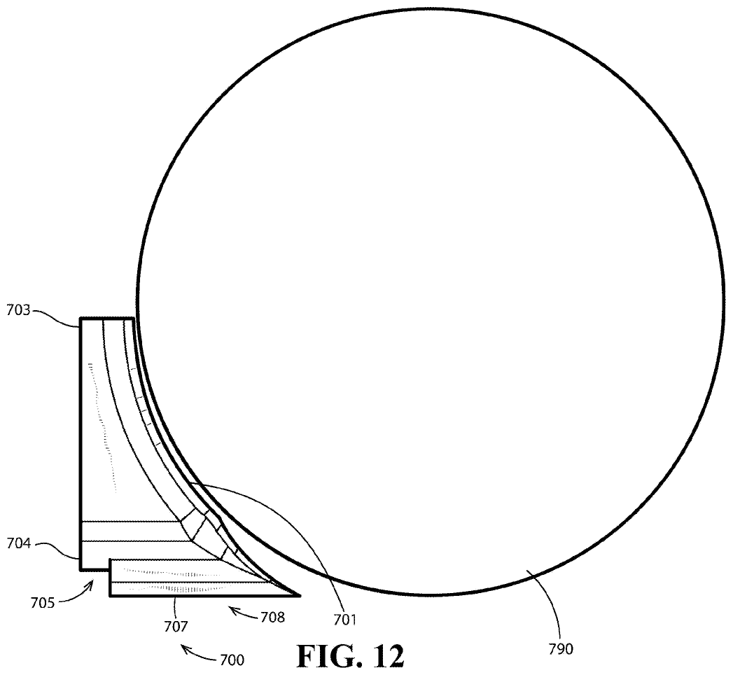

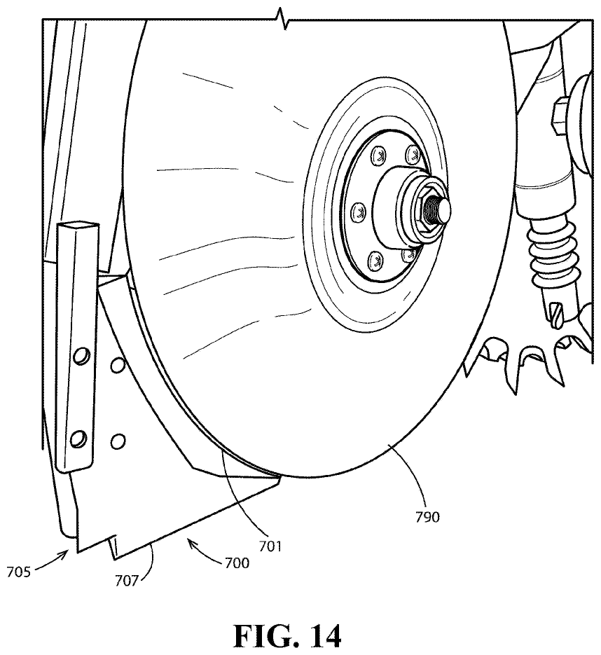

FIGS. 12 to 14 illustrate seed boot 700 in combination with an optional coulter 790. While seed boot 700 can form a trench and deposit seeds on its own, coulter 790 can be included to precut the soil to make it easier for seed boot 700 to form a trench. Coulter 790 can be any coulter used in the agricultural field. As illustrated coulter 790 is a flat disc. Optionally, coulter 790 could be wavy. Coulter 790 is disposed perpendicular to the ground. A radius of curvature of leading edge 701 can optionally match a radius of curvature of coulter 790. Also, the bottom 708 of seed boot 700 can align with the bottom of coulter 790 such that they are both touch the same horizontal plane.

Seed boot 700 can be attached to frame 14 of row unit 200 via bracket 720. Examples of row units can be found in PCT Publication Nos. WO2012/129442A2, WO2013/022835A1, WO2016/077651A1, and WO2017/143125A1. Seed from seed meter 13 are conveyed through conduit 713 to seed boot 700. An example of a seed meter 13 is described in PCT Publication Nos. WO2012/129442, WO2016/077651, and WO2007/024646.

Seed boot 700 can provide a narrower trench as compared to double disc openers, single disc openers, or typical seed boots. Having a narrower trench allows for a seed to be placed into the trench in the same orientation as it was placed because there is less room for the seed to be moved once it is placed in the furrow. This can be a benefit when placing oriented seeds.

Examples of orientation systems include U.S. Provisional Application Nos. 63/262,360, filed 11 Oct. 2021; 63/262,361, filed 11 Oct. 2021; and 63/262,362, filed 11 Oct. 2021, and PCT Publication Nos. WO2018013858A1, WO2018013859A1, WO2018013860A2, and WO2018013861A1. One particular seed orienter is described in U.S. Patent Publication No. US2020/0367425A1. Examples of acceleration wheels described in Application Nos. 63/262,361 and 63/262,362 are described in PCT Publication Nos. WO2013/049198, WO2014/018717, and WO2017/011675, and which are available in the SpeedTube™ system from Precision Planting LLC of Tremont, Illinois.

Seeds leaving the above seed orientation systems can travel through conduit 713 to seed boot 700 for placement in the seed trench, which will allow the seeds to maintain their orientation.

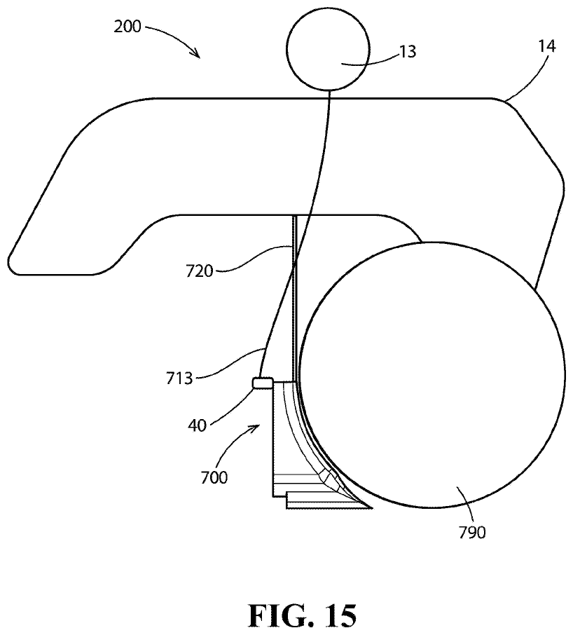

FIG. 15 illustrates seed orientation seed orientation coil assembly 40 from US2020/0367425A1 receiving seed from conduit 713 and dispensing seed into the trench via seed boot 700. Seed coil assembly 40 can be connected to seed boot 700 or to bracket 720.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures, but is to be accorded the widest scope consistent with the spirit and scope of the appended claims.

1. A seed boot comprising:
a leading edge;
a channel for transporting seed opposite the leading edge, wherein the channel has a first end and a second end, and further comprising a channel exit at the second end;
a wedge for forming a trench disposed at a bottom of the seed boot, wherein the wedge extends from the leading edge and terminates before the channel exit.

2. The seed boot of claim 1, wherein the wedge is v-shaped.

3. The seed boot of claim 1, wherein the second end has sloped walls sloped inward and downward towards the channel exit.

4. The seed boot of claim 1, wherein the leading edge is knife shaped.

5. The seed boot of claim 1, wherein the wedge has walls having an angle β with respect to vertical, and the seed boot has lower walls having an angle α with respect to the vertical, and angle α is different from angle β.

6. The seed boot of claim 5, wherein angle α is greater than angle β.

7. The seed boot of claim 1 further comprising:
a row unit comprising a row unit frame;
a coulter rotationally attached to the frame;
wherein the seed boot is disposed behind the coulter.

8. The seed boot of claim 7, wherein the coulter is a flat disc.

9. The seed boot of claim 7, wherein the coulter is wavy.

10. The seed boot of claim 7, wherein a curvature of the leading edge is the same as a curvature of the coulter.

11. The seed boot of claim 7, wherein a bottom of the seed boot is aligned with the coulter in a horizontal plane.
